(19) United States
(12) Patent Application Publication
(10) Pub. No.: US 2012/0159384 A1
(43) Pub. Date: Jun. 21, 2012

(54) MULTI-LEVEL IMAGE VIEWING

(75) Inventors: Michael Zyskowski, Snohomish, WA (US); Xin-Yi Chua, Brisbane (AU)

(73) Assignee: Microsoft Corporation, Redmond, WA (US)

(21) Appl. No.: 12/973,933

(22) Filed: Dec. 21, 2010

(51) Int. Cl. G06F 3/048

(52) U.S. Cl. 715/790; 715/781; 715/799; 715/801

(57) ABSTRACT

An image viewing system may display multiple levels of images, where images with different data or other information may be presented at each level. The levels may represent different information derived from or related to the data from which the images were derived. Within each level, different levels of resolutions of the images may be presented to allow a user to zoom into and out from the data. Some embodiments may present two or more levels of images on the same display, where one level may represent data zoomed into from a higher level, and where the views of the images may be coordinated with each other. In some embodiments, the images may be pre-processed images, while other embodiments may have dynamically generated images.

### BACKGROUND

Images are a powerful mechanism for conveying information. Numerical data, along with mapping information, topology, and even textual information may be conveyed through many different types of images and graphical representations of information.

In many cases, images may be presented with different levels of detail. For example, a map may be displayed at a very high level to show a large area, but may be zoomed in to show a more detailed level of information.

### SUMMARY

An image viewing system may display multiple levels of images, where images with different data or other information may be presented at each level. The levels may represent different information derived from or related to the data from which the images were derived. Within each level, different levels of resolutions of the images may be presented to allow a user to zoom into and out from the data. Some embodiments may present two or more levels of images on the same display, where one level may represent data zoomed into from a higher level, and where the views of the images may be coordinated with each other. In some embodiments, the images may be pre-processed images, while other embodiments may have dynamically generated images.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a hierarchical image system.

FIG. 2 is a flowchart illustration of an embodiment showing a method for preparing data for display.

FIG. 3 is a flowchart illustration of an embodiment showing a method for displaying data representations.

FIG. 4 is a diagram illustration of an example embodiment showing a user interface.

### DETAILED DESCRIPTION

An image presentation mechanism may present several levels of images, where each level of images may contain data not found in at least one other level. The levels of images may be derived from or related to an underlying set of data, and each level of images may be a successively lower resolution view of the underlying data. In some cases, the levels may contain data not found in other levels.

The image presentation mechanism may present two or more levels of images in a coordinated view. The higher level images may contain a broader view of the data, while lower level images may contain more detailed views. When two or more levels are presented in a single user interface, the viewing range of a lower level view may be show in the higher level view.

In many embodiments, the image presentation mechanism may be an interactive mechanism for a user to navigate, investigate, and annotate the images and the underlying data represented by the images. Such embodiments may allow a user to zoom into and out of the data, pan, scroll, and otherwise navigate using one or more of the images from different levels for navigation.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

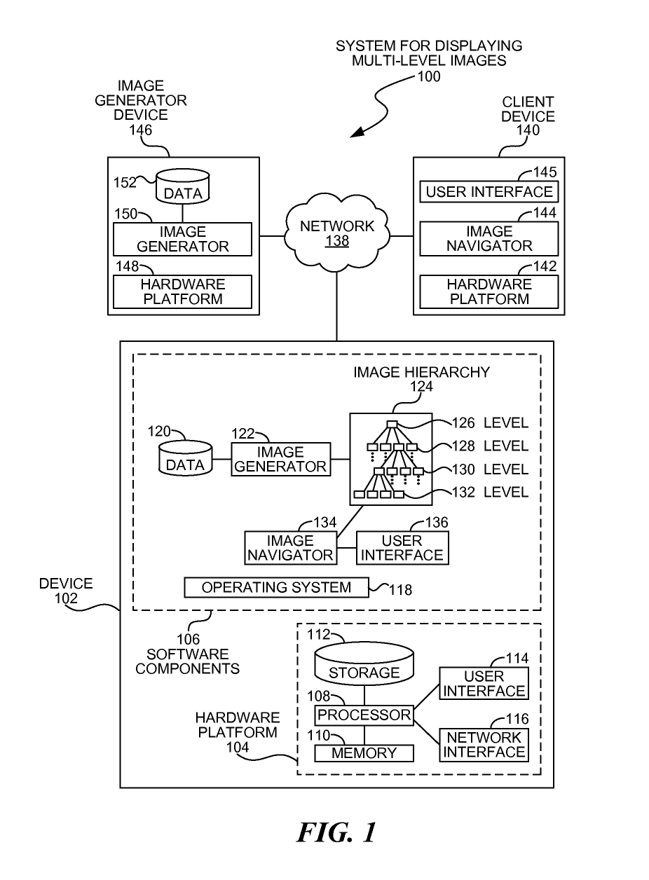

FIG. 1 is a diagram of an embodiment 100, showing a system that may generate a user interface to display various representations of raw data. Embodiment 100 is a simplified example of a system that may generate several layers of images to represent data, and then display the images in an interactive user interface that may allow a user to navigate to various locations within the data and to annotate the data.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 may represent a system that may process and display data. The data may be displayed in a multi-level manner so that the data may be navigated by a user. The multi-level manner may include several different representations of the data, and may include data at one level that may not be presented at a different level.

The multi-level display may include several representations of the raw data. In some levels, information may be included in a level that may not be included on another level. The user interface on which the data are displayed may be an interactive user interface through which a user may navigate the data and perform various operations on the data.

The multi-level display may include representations of the raw data at different levels of detail. For example, a high level representation may include an overview image of the entire dataset that may show general shapes or trends in the data, while a lower level representation may include details at the level of individual data points. Some embodiments may include intermediate levels that have other representations of the data.

Some levels may display data that may not be found on other levels. For example, an intermediate level may include trend lines, local minima or maxima, or other local data that may be derived from the raw data and may not be relevant at a lower resolution or may be too detailed for a higher level image. The additional data at certain levels may be selected to be relevant at a range of resolution that may or may not be applicable to other ranges of resolution.

Many embodiments may have interactive user interfaces. The interactive user interfaces may allow a user to navigate the various representations of the data by panning, zooming, scrolling, scaling, or other operations. In many embodiments, two or more of the displayed levels may have interactive controls such as scroll bars, zoom sliders, or other controls. In some embodiments, the user controls may allow a user to hold and drag an image in order to pan, use pinching motions for zooming in or out, or other user interface controls.

When several levels are displayed on the same user interface, the levels may be synchronized or coordinated so that the images of all the levels show the same range of data. In many embodiments, each layer may represent successively larger ranges of data. In some embodiments, some layers may represent different views or alternative representations of similar ranges of data.

In embodiments with synchronized views of the data, a user's change in the display of one layer may cause displays in the other layers to change accordingly. For example, a user may select a high level display and may scroll the display to another position within the raw data. As the user scrolls through the display, any other images may also pan so that the other images may display the same portion of the raw data. Such an embodiment may allow a user to navigate the data in a coarse manner using a higher level image, and to navigate the data in a precise manner using a lower level image.

Many embodiments may enable zooming or resealing of an image within a certain level. Such embodiments may be implemented by scaling an image representing the layer or by providing multiple sets of images that may represent different scaled views of the raw data. When multiple sets of images are created, a zoom or rescale operation may be performed by selecting a set of images corresponding to a desired zoom level and displaying the images.

Some embodiments may create several images that may represent each layer. Such cases may be useful to break down a very large image into many smaller images that may be easier to manipulate and to store and retrieve. In some such cases, a data range to display may cross the data range of two or more images. In such cases, two or more images may be stitched together to form a single image to display.

A data presentation system may operate on a device 102. The device 102 is illustrated having hardware components 104 and software components 106. The device 102 as illustrated represents a conventional computing device, although other embodiments may have different configurations, architectures, or components.

In many embodiments, the device 102 may be a personal computer or code development workstation. The device 102 may also be a server computer, desktop computer, or comparable device. In some embodiments, the device 102 may still also be a laptop computer, netbook computer, tablet or slate computer, wireless handset, cellular telephone, or any other type of computing device.

The hardware components 104 may include a processor 108, random access memory 110, and nonvolatile storage 112. The hardware components 104 may also include a user interface 114 and network interface 116. The processor 108 may be made up of several processors or processor cores in some embodiments. The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface 114 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

The software components 106 may include raw data 120 that may be used to produce multiple images and representations in different layers. An image generator 122 may create an image hierarchy 124 that may include levels 126, 128, 130, and 132, where each layer may represent a different view of the data 120. The various layers may represent the data 120 in different resolutions, with the higher levels having a broader view of the data and lower levels may have a more detailed view.

The image hierarchy 124 may be defined such that each level may represent an aggregation of a lower level. For example, the highest level 126 may represent the sum or aggregate of the images of level 128. In many embodiments, a single image within an upper level may represent the raw data represented by a discrete number of images from a lower level. For example, a top level image may represent four, eight, ten or some other number of images from a next lower level.

An image navigator 134 may produce a user interface 136 that may be presented on an output device for a user to consume. In many embodiments, the user interface 136 may be an interactive user interface where a user may navigate the data through the various images.

In some embodiments, a client device 140 may perform some of the operations of the device 102. The client device 140 may communicate with the device 102 over a network 138. The client device 140 may have a hardware platform 142 on which an image navigator 144 may generate a user interface 145. In such an embodiment, the client device 140 may retrieve images from the image hierarchy 124 and display the images on the client device 140.

In some embodiments, the image navigator 134 may generate an interactive user interface that may be displayed on a client device 140. In such embodiments, the user interface 136 may be defined using Hyper Text Markup Language (HTML), a scripting language, or other definition that may be used by a browser or other application that may consume the user interface 136.

Some embodiments may perform the image generation operation on an image generator device 146. The image generator device 146 may have a hardware platform 148 on which an image generator 150 may convert the data 152 into an image hierarchy. The operations of the image generator 150 may be similar to those of the image generator 122.

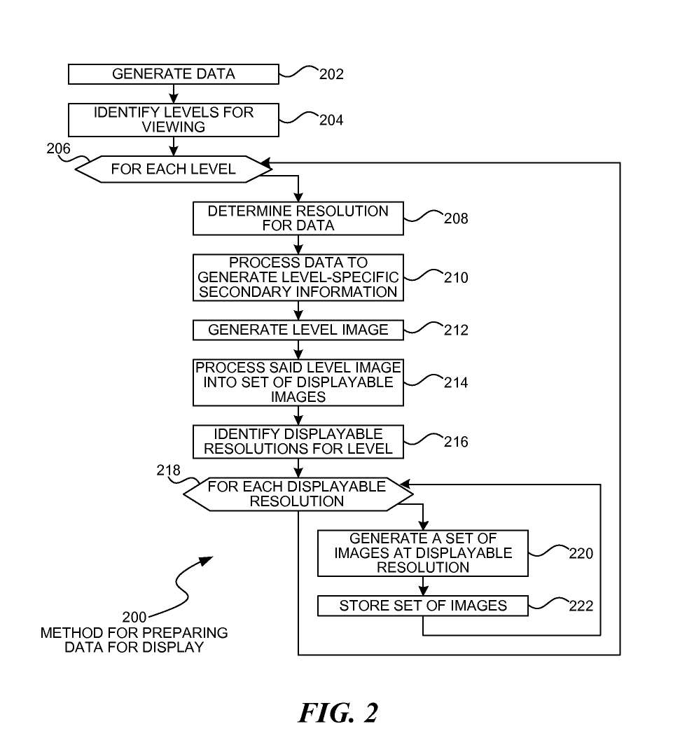

FIG. 2 is a flowchart illustration of an embodiment 200 showing a method for preparing data for display. The process of embodiment 200 is a simplified example of generating an image hierarchy, as may be performed by an image generator 122 or 150 to process raw data and generate several levels of images that may be displayed using an image navigator.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a method whereby raw data may be processed into an image hierarchy, then stored for future viewing and browsing. Such embodiments may be useful when the data do not change frequently, for example, or when the images may take large amounts of computational time to produce, such as when the data sets may be very large.

In other embodiments, raw data may be processed on demand to generate images. Such embodiments may be useful for cases where the raw data may be sufficiently small that the computational time used to generate the images may not adversely affect performance, when the data change frequently, or for other conditions.

In block 202, data may be generated. The source of the data may be any type of data generation or collection mechanism, such as the output of a sensor, computation, or other data source.

The levels for viewing the data may be defined in block 204. The levels may be chosen merely to break the viewable data into manageable hierarchical blocks. In some embodiments, certain levels of detail may be useful based on the type of data. For example, a dataset of stock quotes or other financial data may be useful at a daily, weekly, or monthly level. In other examples, weather related data may be useful in seasonal or yearly levels, while geographic data may be useful in county, state, and country levels.

Each level may be processed in block 206. For each level in block 206, a resolution level for the data may be determined in block 208. The resolution level may define how much of the data may be represented in an image for the current level. For example, a resolution level where many data points may be represented by a single pixel may be processed to take an average for those data points.

In block 208, the data may be further processed to generate secondary information that may be specific to the level. In some embodiments, certain levels may have secondary information that may be gathered from a secondary data source, such as a second database, or the data within the level may be processed to generate statistics at that level. For example, a financial time series may have a level representing weekly data. The level may be analyzed to generate a moving average based on weekly data. Other levels may have other statistics or secondary data generated for those levels.

In block 212, a level image may be generated that represents the data at the current level. The level image may be a graph, map, or any other image that may represent the data at the current level. In some embodiments, different types of images may be generated for different levels.

The large image generated in block 212 may be processed in block 214 to generate displayable images. The displayable images may be tiles of the large image, where tiles may be subsets or sections of the large image. In some embodiments, the tiles may be stitched together or joined to create a single displayed image. Some embodiments may create tiles that may be smaller or larger than a displayed image.

Each level may have multiple displayable resolutions defined in block 216. The displayable resolutions may be two, three, or more different resolutions for the level. A displayable resolution may be a resolution of the image that may be presented on a user interface. For each displayable resolution in block 218, a set of images for each displayable resolution may be created in block 220 and the set of images may be stored in block 222.

The set of displayable images may be used to display the image at different resolutions when a user zooms in or out of a particular image. By having a set of pre-processed and pre-defined images at different resolutions, a new resolution may be displayed by merely substituting the new images. If the several sets of images were not present, a computer processor may process an image to create a new resolution of the image at each zoom level.

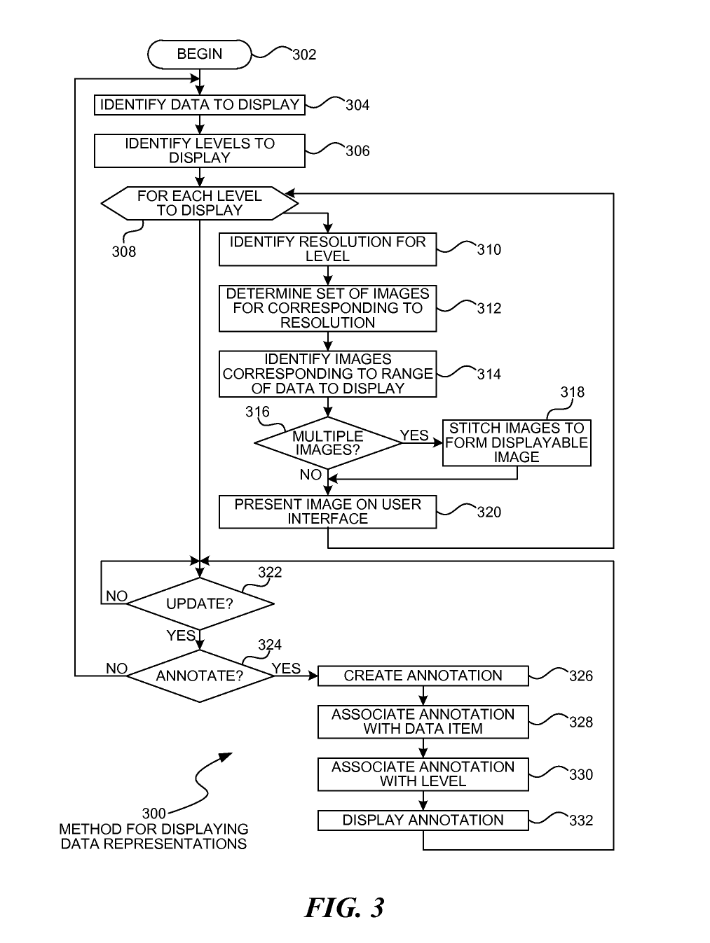

FIG. 3 is a flowchart illustration of an embodiment 300 showing a method for displaying data representations. The process of embodiment 200 is a simplified example of creating and operating an interactive user interface that may have multiple synchronized images that may display representations of raw images, as may be performed by an image navigator, such as the image navigator 134 or 144 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The process of embodiment 300 may create or update an interactive user interface that may display images representing different levels or views of a dataset. In many embodiments, the highest level may represent a macro view or overview of the data, with successively lower levels providing additional detail about the raw data. Some embodiments may allow a user to interact with the images to navigate and annotate the data.

The process may begin in block 302.

In block 304, the data to display may be identified, along with the levels to display in block 306. The data to display may define a starting value, range, or other definition of the portions of data to display. The levels to display may define which of the various views of the data a user may wish to see. In some embodiments, the levels may be predefined, while in other embodiments, the levels may be selectable and changeable by the user.

For each level in block 308, the resolution of the level may be identified in block 310. A set of images corresponding to the selected resolution may be identified in block 312, and those images relating to the range of data may be identified in block 314. If there are multiple images covering the range of data in block 316, the images may be stitched together in block 318 to create a displayable image. If there is only a single image representing the data in block 316, or after creating a displayable image in block 318, the image may be presented on the user interface in block 320.

After each level may be created and presented, the user interface may be presented on a display. In many embodiments, the display may have various input mechanisms, such as pointing devices like a mouse, stylus, or trackball, or a touchscreen that may receive and interpret various gestures. When a user may interact with the user interface, the user interface may be updated in block 322. If the update is not an annotation in block 324, the process may return to block 304 with updated selections of data ranges, levels, level resolutions, or other changes, and the user interface may be updated by the process beginning at block 304.

If the update is an annotation in block 324, an annotation may be created in block 326. An annotation may be any type of change that a user may wish to make to the images or data on the user interface. In a typical embodiment, the annotation may be a text note, hyperlink, image, or other information that a user may add to the data.

Once the annotation is created in block 326, the annotation may be associated with a data item in block 328 and a level in block 330. The annotation may be displayed in block 332 and the process may return to block 322.

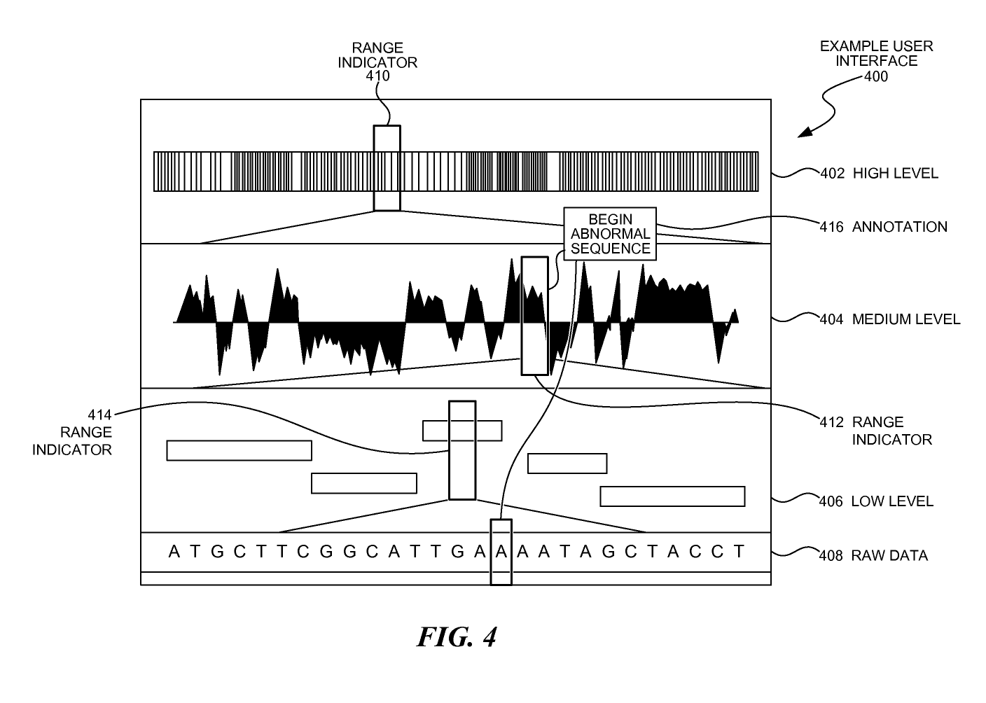

FIG. 4 is a diagram illustration of an example embodiment 400 showing a sample user interface. Embodiment 400 may illustrate an example where a multi-level interactive user interface may be used to display, navigate, and annotate genomic data.

Embodiment 400 is an example of an interactive user interface that may be produced by the method of embodiment 300, and may display three levels of the data, along with the raw data.

In the example of genomic information, a gene sequence may have many millions or even billions of data points in the raw data, and a multi-level display may be an efficient mechanism for a researcher to operate with the data.

In the example of embodiment 400, three levels of data may be presented as a high level 402, medium level 404, and low level 406. The raw data may 408 may also be displayed. Each of the various levels may represent different views of the raw data. The high level 402 may illustrate an entire gene sequence, while the medium level 404 may illustrate the directional nature of the genomic sequence. The low level 406 may illustrates specific types of sequences, while the raw data 408 may be the individual genes.

In order to generate the images within the embodiment 400, the raw data 408 may be processed into different images using different routines or algorithms. Each image representing a level may have different data that may not be found in other levels, or data that may be appropriate for the approximate resolution of the data.

The various levels may be synchronized to display linked views of the data. For example, the high level 402 may be displayed with a range indicator 410 that may show the range represented by the medium level 404. Similarly, the medium level 404 may have a range indicator 412 that may show the range of data displayed in the low level 406.

The levels may be synchronized so that at least a common data point or range of data may be displayed on all the levels simultaneously. For example, the range of data in the low level 406 may be shown within the range indicator 412 of the medium level 404, which may also be shown within the range indicator 410 of the high level 402.

In many embodiments, a user may be able to interact with the data in several different manners. The user may be able to navigate through the data by scrolling any of the images within any of the levels. For example, a user may be able to click and drag the range indicator 410, which may cause the images of the medium level 404 and low level 406 to scroll to match the range indicated by the range indicator 410. In another example, a user may click and drag the image in the medium level 404 to move the image from one side to another, which may cause the range indicator 410 and the image in the low level 406 to update accordingly.

In some embodiments, a user may be able to zoom into and out from a particular image. For example, a user may be able to zoom into the medium level and thereby change the resolution of the image. By zooming into the image, more of the detail of the image may be displayed, or even additional data may be displayed that was not available in the previous level, but the range of data may be lower. When such a change may be made, the range indicator 410 may grow or shrink accordingly to match the actual range of data displayed in the medium level 404.

Many embodiments may have annotation features. An annotation 416 may be shown in embodiment 400. The annotation 416 may be linked to the medium level 404 as well as a particular data point, as shown by the lines from the annotation to the areas within the medium level 404 and the raw data 408.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a plurality of images arranged in different levels, each of said levels representing different representations of underlying data and further representing different resolutions of said underlying data, at least one of said levels comprising representations of said underlying data not found in another of said levels; and
displaying at least one image from each of a plurality of said levels on a user interface.

2. The method of claim 1 further comprising:
coupling said each of said images from each of said plurality of said levels within an interactive user interface.

3. The method of claim 2 said interactive user interface that:
receives user input to navigate said images to a new location within said underlying data; and
updates to said interactive user interface with said new location for each of said plurality of levels.

4. The method of claim 3, said images being received from a pre-defined set of images.

5. The method of claim 3, said images being generated in response to a user input for said images.

6. The method of claim 1, each of said levels comprising a plurality of sets of images representing said levels, each of said sets comprising images having a common resolution for said images within said level.

7. The method of claim 6 further comprising:
receiving user input to change resolution within a first level; and
presenting at least one image from a different set of said images for said one of said levels.

8. The method of claim 7 further comprising:
updating an image within a second level to show a view range for said first level.

9. The method of claim 8, said updating an image comprising placing an overlay on said image.

10. A system comprising:
a set of raw data;
images derived from said raw data, said images comprising a plurality of levels, each of said levels representing views of said raw data at different levels of detail, at least one of said levels comprising data not found in another of said levels;
an image viewer that:
presents at least one image from each of a plurality of said levels on a user interface simultaneously.

11. The system of claim 10, said image viewer that further:
coordinates said at least one image from each of all plurality of levels such that each of said levels presents common data within said raw data.

12. The system of claim 11, said image viewer that further:
identifies a plurality of images representing a range of said raw data to display, said plurality of images being within a first level;
stitches said plurality of levels together form a first image for said first level; and
presents said first image for said first level.

13. The system of claim 11 further comprising:
an image generator that:
receives said raw data;
identifies a plurality of levels of said raw data;
for each of said plurality of levels, creating at least one image representing said each of said plurality of levels;
for a first level, identifying said data not found in another of said levels and creating a representation of said data for said first level.

14. The system of claim 13, said image generator that further:
for each of said levels, creating a plurality of sets of images, each of said sets of images being a different resolution of images for said level.

15. The system of claim 14, said image viewer that further:
presents a first image from a first set of said images for a first level;
receives a zoom command;
identifies a second image from a second set of said images for said first level; and
presents said second image within said user interface.

16. The system of claim 15, said zoom command identifying said first level.

17. The system of claim 15, said zoom command identifying a second level.

18. A system comprising:
a user interface;
an image generator that:
receives raw data;
defines a plurality of levels, each of said levels comprising said raw data in a predefined representation;
for each of a series of levels, processes said raw data to create a plurality of images, said images representing said raw data in said predefined representation;
for a first level, processes said raw data to create data incorporated into said images, said data not being in another of said levels;
an image viewer that:
identifies at least one data item within said raw data;
presents a plurality of images on said user interface, each of said images being associated with a different level and comprising data derived from said at least one data item.

19. The system of claim 18, said user interface being a remote user interface on a client device.

20. The system of claim 18, said image viewer that further:
receives a command from a user, said command being a navigation command;
identifies a second data item within said raw data;
presents a plurality of images on said user interface, each of said images being associated with a different level and comprising data derived from said second data item.
